(19) United States
(12) Patent Application Publication
(10) Pub. No.: US 2014/0026530 A1
(43) Pub. Date: Jan. 30, 2014

(54) STRING TRIMMER HAVING A PIVOTABLE CARRIAGE

(71) Applicant: Jimmy Lawrence Cathcart, Rock Hill, SC (US)

(72) Inventor: Jimmy Lawrence Cathcart, Rock Hill, SC (US)

(21) Appl. No.: 14/041,445

(22) Filed: Sep. 30, 2013

Related U.S. Application Data
(63) Continuation-in-part of application No. 13/329,674, filed on Dec. 19, 2011, now Pat. No. 8,544,247.

(51) Int. Cl. A01D 34/416; A01D 34/84

(52) U.S. Cl. CPC A01D 34/4165; A01D 34/84
USPC 56/12.7

(57) ABSTRACT

The present invention relates to a string trimmer having a pivotable carriage bearing a trimmer portion. The string trimmer typically includes a handle bar support, at least two wheels attached to the handle bar support, and an engine attached to a pivot bar support. The string trimmer typically includes a trimmer portion, which has a rotatable trimmer head and cutting line attached to the rotatable trimmer head. The trimmer portion is capable of rotating between a mowing position, a trimming position and an edging position. The string trimmer also typically includes a rotatable handle bar that has a first handle-bar portion and a second handle-bar portion. The rotatable handle bar is in communication with the trimmer portion.

### CROSS-REFERENCE TO PRIORITY APPLICATION

This application is a continuation-in-part of the commonly owned patent application Ser. No. 13/329,674 filed Dec. 19, 2011, in the US Patent Office which is hereby incorporated by reference in its entirety.

### FIELD OF THE INVENTION

The present invention relates to a string trimmer having a pivotable carriage with a trimmer portion.

### BACKGROUND

String trimmers are commonly used to cut grass and other vegetation. Both hand-held and wheel-mounted string trimmers are commonly employed. U.S. Pat. No. 4,936,886 discloses a wheel-mounted string trimmer having a trimmer head that is capable of rotating between a horizontal plane, a vertical plane, and an intermediate plane. This rotation of the trimmer head facilitates mowing, trimming and edging operations. That said, the steps required for rotating the trimmer head are rather involved. Accordingly, a need exists for an improved string trimmer capable of performing mowing, trimming and edging operations. What is more, a need exists for an improved string trimmer that is better able to protect its operator from debris.

### SUMMARY

Accordingly, in one aspect, the present invention embraces a string trimmer having a pivotable carriage capable of a plurality of positions. The string trimmer typically includes a handle bar support, at least two wheels attached to the handle bar support, and an engine (e.g., a gasoline engine) attached to a pivot bar support. The string trimmer includes a trimmer portion, which has a rotatable trimmer head and cutting line attached to the rotatable trimmer head. The rotatable trimmer head defines a cutting plane. To facilitate mowing, trimming and edging operations, a pivotable carriage is provided that is capable of rotating/pivoting among a mowing position, a trimming position and an edging position.

Advantageously, the invention provides a lever positioned at an upper portion of the handle bar support. The lever moves the carriage and trimmer portion from the mowing position to the trimming position (intermediate of the mowing and edging position) when the first handle-bar portion is in a user position.

A drive-shaft housing connects the trimmer portion to the handle bar support. A drive shaft positioned substantially within the drive-shaft housing transfers rotational motion from the engine to the rotatable trimmer head.

The string trimmer also includes a rotatable handle bar that has a first handle-bar portion and a second handle-bar portion. A handle-bar support connects the rotatable handle bar to the handle bar support. The rotatable handle bar is in communication with the carriage and hence trimmer portion such that: (i) the first handle-bar portion is in a user position when the trimmer portion is in a mowing position, (ii) the first handle-bar portion is in a user position when the trimmer portion is in a trimmer position, and (iii) the second handle-bar portion is in a user position when the trimmer portion is in an edging position. The second handle bar is positioned on the opposite side of the string trimmer as the trimmer portion when the trimmer portion is in an edging position.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1A schematically depicts a rotatable string trimmer in a mowing position.

FIG. 1B schematically depicts a rotatable string trimmer in a trimming position in accordance with the present invention.

FIG. 2 schematically depicts a rotatable string trimmer having a trimmer portion in an edging position in accordance with the present invention.

FIG. 3 schematically depicts a rotatable handle bar in accordance with the present invention.

FIG. 4 schematically depicts a handle-bar pulley in accordance with the present invention.

FIGS. 5-8 schematically depict a rotatable handle bar being rotated between a trimming position and an edging position.

FIG. 9 schematically depicts a drive-shaft-housing pulley and pivot bar support in accordance with the present invention.

FIGS. 10-12 schematically depict the rotation of a drive-shaft-housing pulley so that a trimmer portion is rotated from a mowing position, to a trimming position and to an edging position.

### DETAILED DESCRIPTION

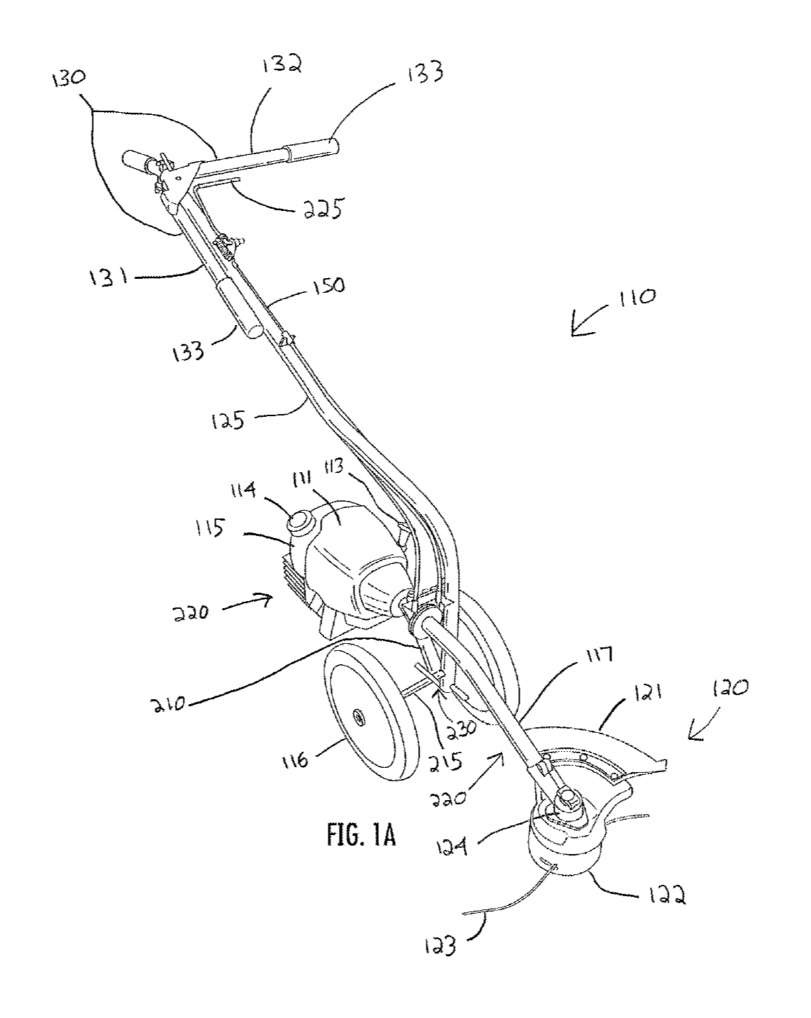

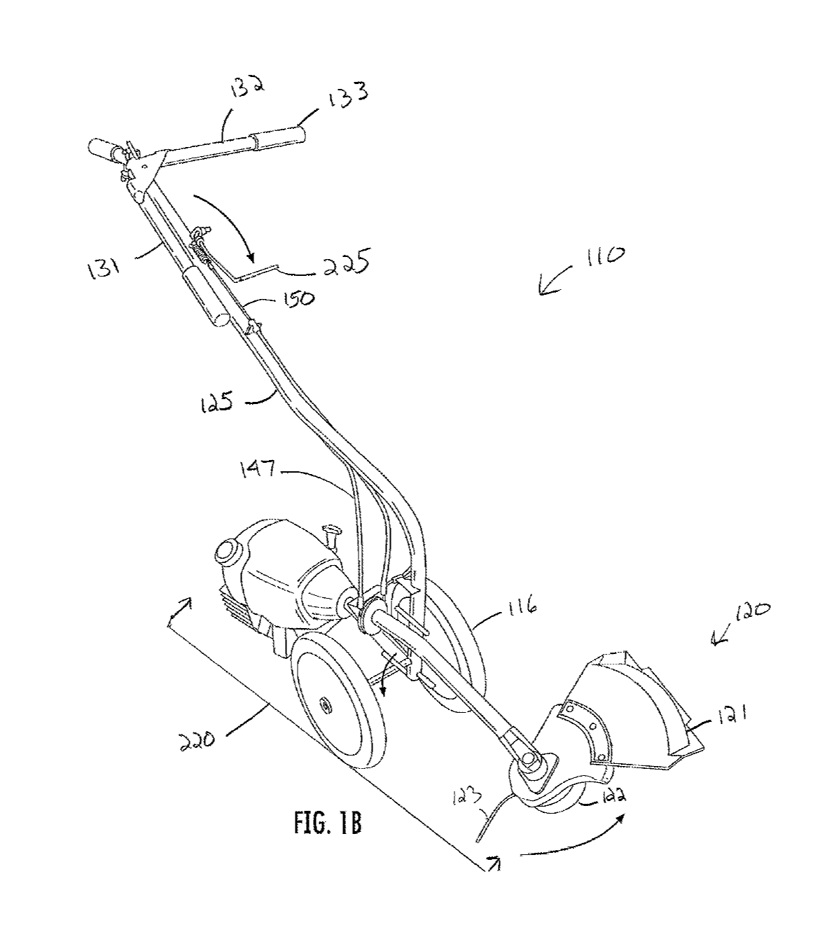

In one aspect, the present invention embraces a rotatable string trimmer. In this regard, FIG. 1A depicts an exemplary rotatable string trimmer 110 in accordance with the present invention.

As depicted in FIG. 1A, the rotatable string trimmer 110 includes a handle bar support 125, a pivot bar support 210 rotatably connected to the handle bar support, two or more wheels 116 attached to the handle bar support by a shaft 215, wherein the shaft 215 provides a pivot point 230 for the pivot bar support 210, a pivotable carriage 220 comprising an engine 111, a draft shaft housing 117 and a rotatable trimmer portion 120, a rotatable handle bar 130 connected to the handle bar support and in communication with the pivotable carriage (and the trimmer portion), and a lever 225 positioned at an upper portion of the handle bar support.

The engine 111 typically includes a gasoline storage tank 115. A gas cap 114 typically provides access to the gasoline storage tank 115. The engine 111 also typically includes a pull cord 113 for starting the engine 111. Although FIG. 1A depicts the engine 111 as being a gasoline engine, other types of engines, such as an electric motor, are within the scope of the present invention.

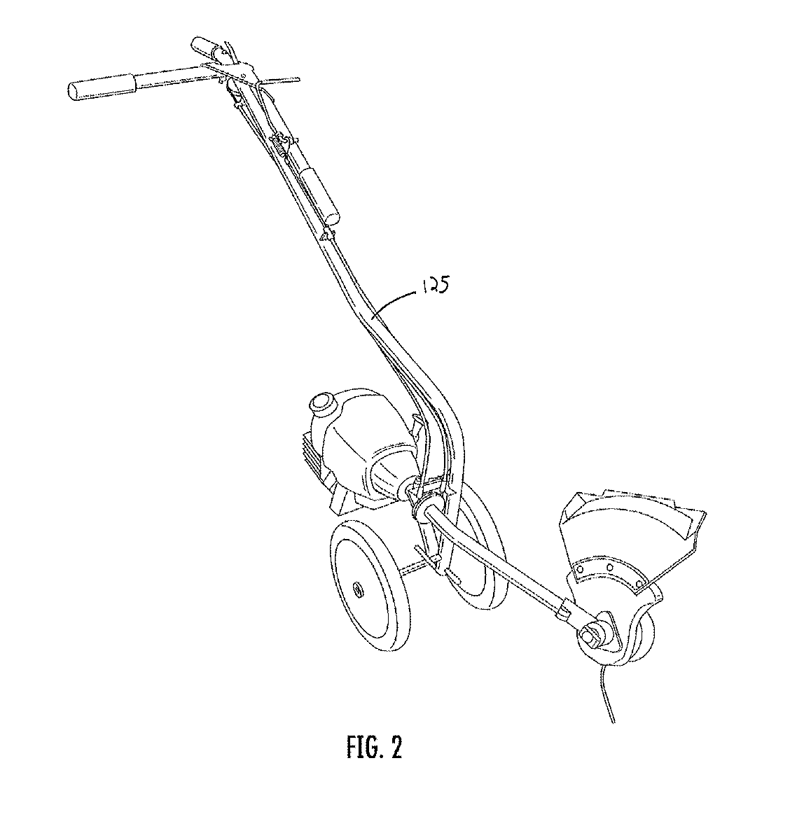

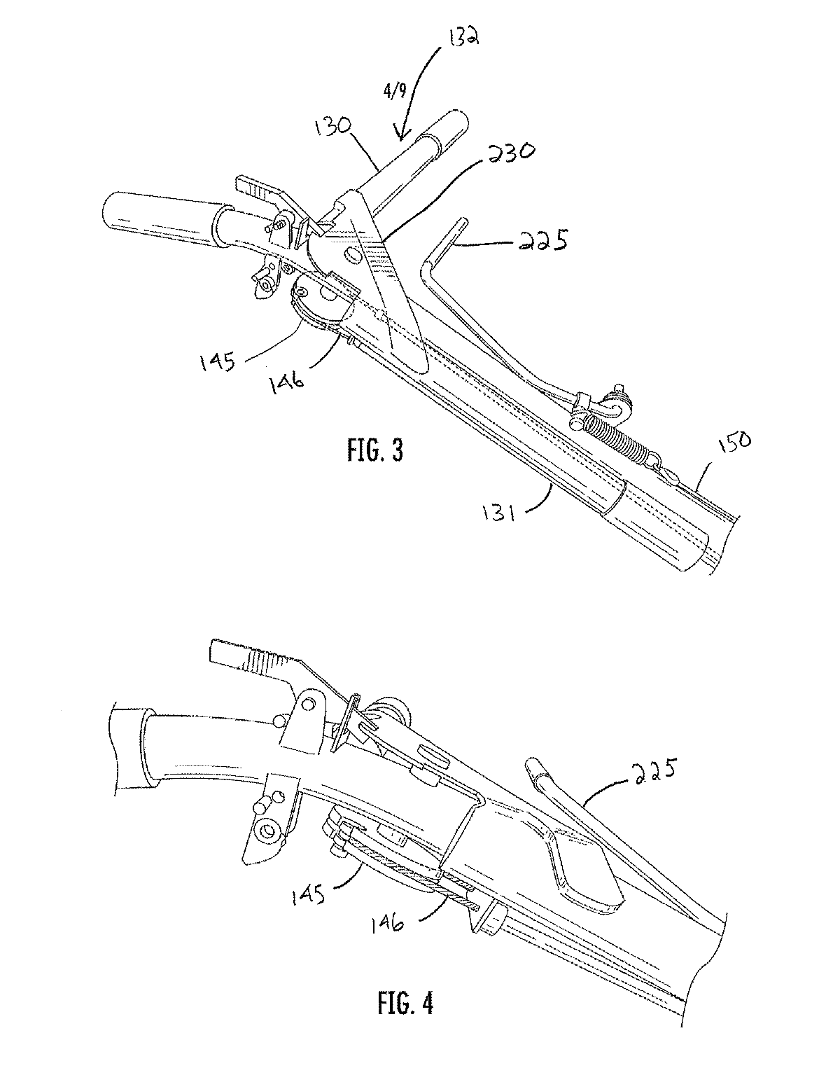

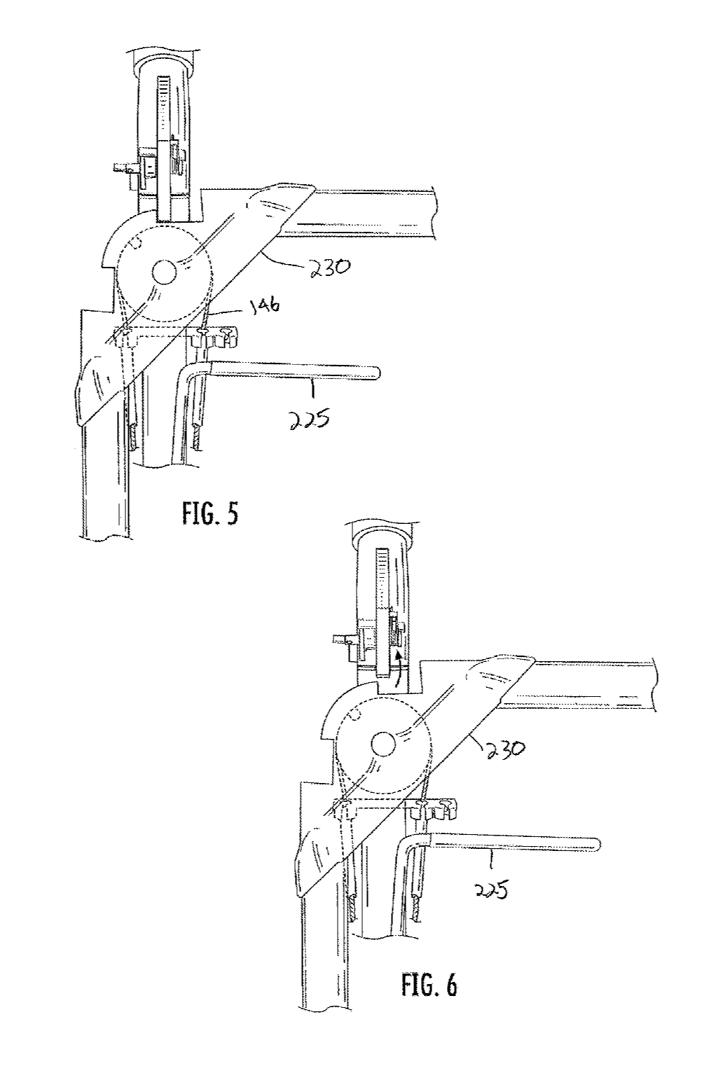

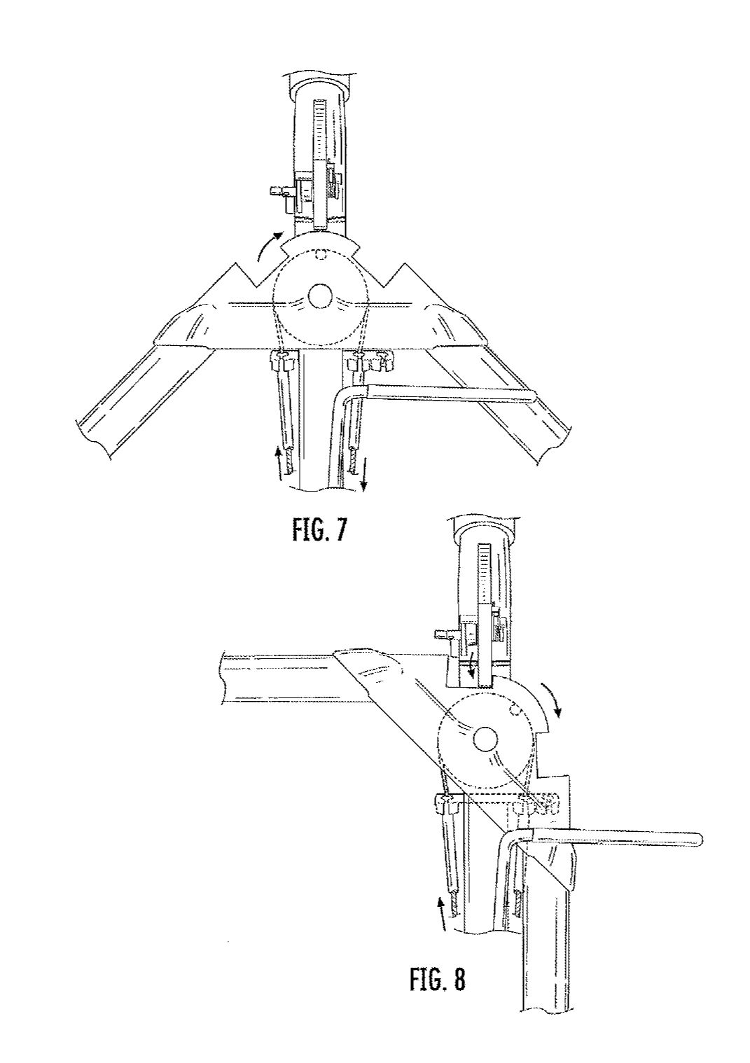

The carriage 220 is rotatably attached to the pivot 210 bar support such that the rotatable trimmer portion 120 rotates between a mowing position (FIG. 1A), a trimming position (FIG. 1B), and an edging position (FIG. 2).

When the trimmer portion 120 is in a mowing position, the cutting plane is approximately parallel to a flat surface if the string trimmer were positioned on the flat surface. When the trimmer portion is in a trimming position, the rotatable trimmer head is positioned such that the cutting plane is at an angle of between about 10 degrees and 30 degrees relative to a flat surface, if the string trimmer were positioned on the flat surface.

When the trimmer portion is in an edging position, the rotatable trimmer head is positioned such that the cutting plane is at an angle of between about 30 degrees and 90 degrees relative to a flat surface, if the string trimmer were positioned on the flat surface.

As configured, the rotatable trimmer head 122 rotates counterclockwise. The rotatable handle bar 130 includes a first handle-bar portion 132 and a second handle-bar portion 131. The first handle-bar portion 132 is in a user position when the trimmer portion 120 is in a mowing position (FIG. 1A). The first handle-bar portion 132 is also in a user position when trimmer portion 120 is in a trimming position (FIG. 1B). The second handle-bar portion 131 is in a user position when the trimmer portion 120 is in an edging position (FIG. 2). The second handle-bar portion 131 is positioned on the opposite side of the string trimmer 110 as the trimmer portion 120 when the trimmer portion 120 is in an edging position.

Stated differently, the rotatable handle bar 130 and the trimmer portion 120 are capable of rotating between a mowing position depicted in FIG. 1A, a trimming position depicted in FIG. 1B, and an edging position depicted in FIG. 2. In the mowing position, the cutting plane of the trimmer portion 120 (i.e., the plane defined by the cutting line 123 when the trimmer head 122 rotates) is typically approximately parallel to the ground. In other words, in the mowing position, the cutting plane of the trimmer portion 120 would be approximately parallel to a flat surface upon which the rotatable string trimmer 110 is positioned. Moreover, in the mowing position the first handle-bar portion 31 is in a user position (e.g., approximately perpendicular to the handle-bar support 12).

As noted above, in the trimming position, the rotatable trimmer head is positioned such that the cutting plane is at an angle of between about 10 degrees and 30 degrees relative to a flat surface, if the string trimmer were positioned on the flat surface.

In the edging position, the cutting plane of the trimmer portion 120 is positioned at an angle (e.g., between about 30° and 90% such as about 45°) relative to the ground. Preferably, the cutting angle for edging is typically about 90°.

FIG. 2 depicts the trimmer portion 120 being on the right side and the second handle-bar portion 131 being on the left side of the rotatable string trimmer 110. This positioning prevents debris being thrown reward from hitting a user.

The lever 225 is positioned at an upper portion of the handle bar support 125 and upon forward movement moves the trimmer portion 120 from the mowing position to the trimming position, which is intermediate of the mowing and edging position, when the first handle-bar portion 132 is in a user position. The lever is moveably attached to the pivot bar by a cable 150 covered by a cable jacket. The engine 111, drive shaft housing 117, and trimmer portion 120 pivot from the mowing position to the trimmer position when the lever is moved forward.

The revised embodiment also includes a drive shaft that is in communication with the engine 111 and trimmer portion 120. The drive shaft transfers rotational motion from the engine to a trimmer head 122 of the trimmer portion 120. The drive shaft housing 117 connects the trimmer portion 120 to the pivot bar support 210, and the drive-shaft housing substantially encloses the drive shaft.

The rotatable trimmer portion 120 includes the trimmer head 122 and cutting line 123 (e.g., nylon string) attached to the trimmer head. The trimmer head 122 defines a cutting plane, such that the rotatable trimmer portion rotates between the mowing position, trimming position, and edging position. The trimmer head 122 typically rotates counterclockwise (i.e., counterclockwise from the vantage point of someone above the trimmer head).

The trimmer portion 120 also typically includes a gear housing 124, which has gears for transferring rotational motion from the drive shaft to the trimmer head 122. As depicted in FIG. 1A, the trimmer portion 120 typically includes a shield 121 for directing debris away from a user of the rotatable string trimmer 110.

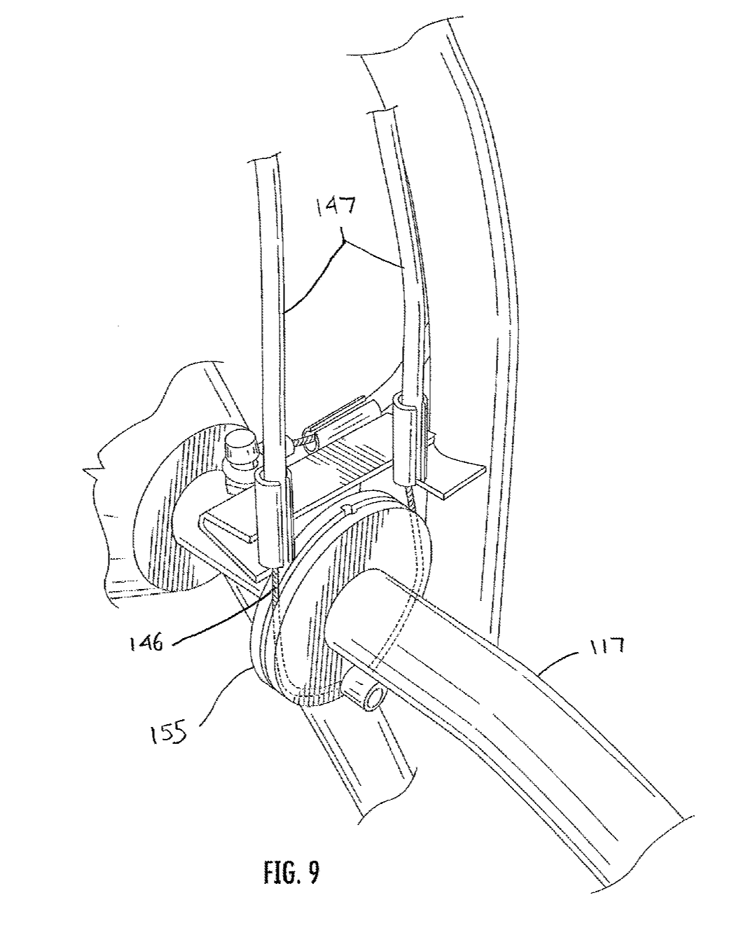

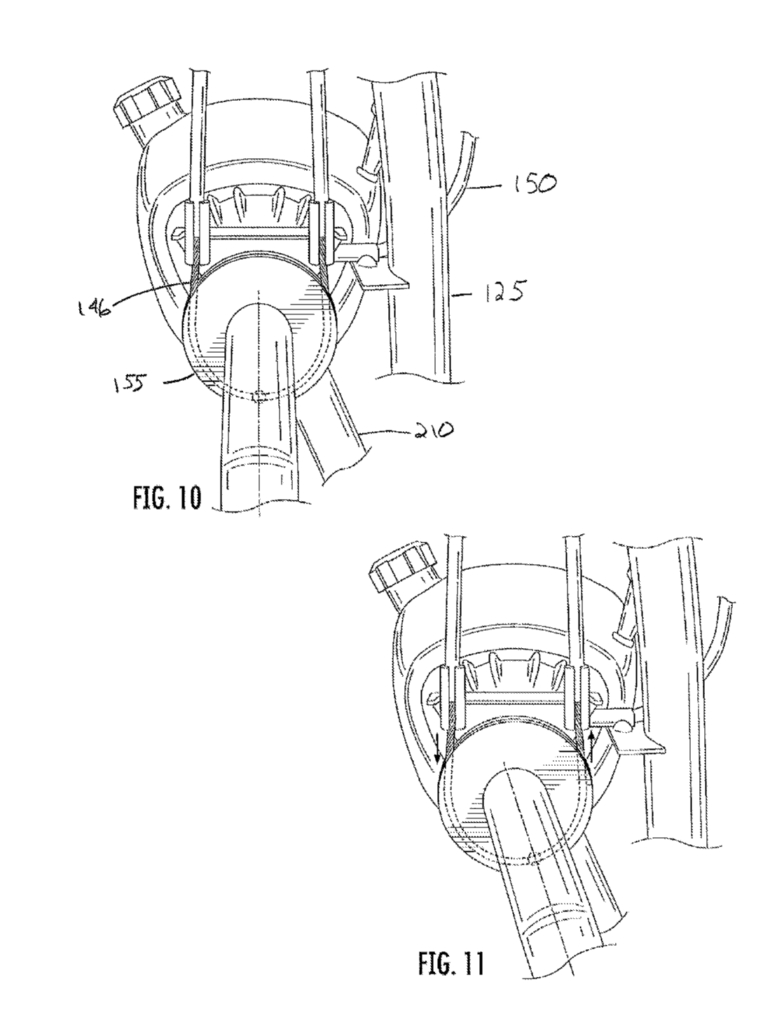

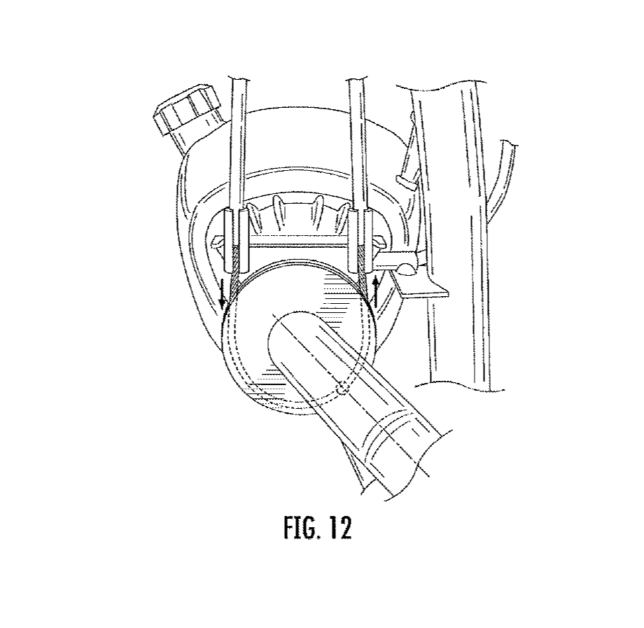

The invention further includes a handle-bar pulley 145 attached to the rotatable handle bar 130, and a drive-shaft-housing pulley 155 attached to the drive-shaft housing 117. A continuous pulley cable 146 is attached to the handle-bar pulley 145 and drive-shaft-housing pulley 155 (see FIG. 9).

A locking mechanism is provided and is attached to the handle-bar support 125, such that when the locking mechanism is engaged, the locking mechanism prevents rotation of the handle-bar pulley 145.

The handle-bar pulley 145 is connected to a pulley shield 230 secured to the first and second handle bar portions 132, 131. The handle-bar pulley 145 is moveable upon movement of the first and second handle bar portions.

The invention also includes a pulley-cable jacket 147 substantially enclosing the pulley cable 146. Movement of the rotatable handle bar winds the continuous pulley cable around the handle-bar pulley and causes the pulley cable to wind around the drive-shaft-housing pulley.

The revised embodiment also includes a gear box attached to the engine 111 of the pivotable carriage 220. The gear box includes gears in communication with the drive shaft/drive shaft housing 117 and rotatable trimmer head 122. The gears are capable of transferring rotational motion from the drive shaft to the rotatable trimmer head. The engine 111 may include an electric motor or a gasoline engine.

FIG. 9 depicts the operation of the drive-shaft-housing pulley 155 in more detail. As previously noted, the drive-shaft housing 117 is attached to the drive-shaft-housing pulley 155. The pulley cable 146 is typically attached to the drive-shaft-housing pulley 155.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A string trimmer providing multiple positions for cutting, comprising:
a handle bar support;
a pivot bar support rotatably connected to said handle bar support;
two or more wheels attached to said handle bar support by a shaft, said shaft providing a pivot point for said pivot bar support;
a pivotable carriage comprising an engine, a draft shaft housing and a rotatable trimmer portion having a trimmer head, said carriage rotatably attached to said pivot bar support, wherein said rotatable trimmer portion rotates between a mowing position, a trimming position, and an edging position;
a rotatable handle bar connected to said handle bar support and in communication with said trimmer portion, said rotatable handle bar comprising a first handle-bar portion and a second handle-bar portion, wherein said first handle-bar portion is in a user position when said trimmer portion is in a mowing position, wherein said first handle-bar portion is in a user position when said trimmer portion is in a trimming position, wherein said second handle-bar portion is in a user position when said trimmer portion is in an edging position, and wherein said second handle bar is positioned on the opposite side of the string trimmer as said trimmer portion when said trimmer portion is in an edging position; and
a lever positioned at an upper portion of said handle bar support and connected to said pivotable carriage by a cable, said lever for moving said trimmer portion from said mowing position to said trimming position intermediate of said mowing and edging position when said first handle-bar portion is in a user position;
wherein said engine, said drive shaft housing, and said trimmer portion pivot from said mowing position to said trimmer position when said lever is moved forward.

2. A string trimmer according to claim 1, further comprising:
a drive shaft in communication with said engine and said trimmer portion for transferring rotational motion from said engine to said trimmer head of said trimmer portion; and
a drive-shaft housing connecting said trimmer portion to said pivot bar support, said drive-shaft housing substantially enclosing said drive shaft;
wherein said rotatable trimmer portion comprising a trimmer head and cutting line attached to said trimmer head, wherein said trimmer head defines a cutting plane, wherein said rotatable trimmer portion rotates between said mowing position, said trimming position, and said edging position.

3. A string trimmer according to claim 2, further comprising:
a handle-bar pulley attached to said rotatable handle bar;
a drive-shaft-housing pulley attached to said drive-shaft housing; and
a continuous pulley cable attached to said handle-bar pulley and to said drive-shaft-housing pulley.

4. A string trimmer according to claim 3, further comprising a locking mechanism attached to said handle-bar support, wherein, when said locking mechanism is engaged, said locking mechanism prevents rotation of said handle-bar pulley.

5. A string trimmer according to claim 3, wherein:
said handle-bar pulley is connected to a pulley shield secured to said first and second handle bar portions, said handle-bar pulley moveable upon movement of said first and second handle bar portions.

6. A string trimmer according to claim 3, further comprising a pulley-cable jacket substantially enclosing said pulley cable.

7. A string trimmer according to claim 3, wherein movement of said rotatable handle bar winds said pulley cable around said handle-bar pulley and causes said pulley cable to wind around said drive-shaft-housing pulley.

8. A string trimmer according to claim 2, further comprising a gear box attached to said engine of said pivotable carriage, said gear box comprising gears in communication with said drive shaft and said rotatable trimmer head, said gears being capable of transferring rotational motion from said drive shaft to said rotatable trimmer head.

9. A string trimmer according to claim 1, wherein said engine is an electric motor.

10. A string trimmer according to claim 1, wherein said engine is a gasoline engine.

11. A string trimmer according to claim 1, wherein, when said trimmer portion is in a mowing position, the cutting plane is approximately parallel to a flat surface, if the string trimmer were positioned on the flat surface.

12. A string trimmer according to claim 1, wherein, when said trimmer portion is in an edging position, said rotatable trimmer head is positioned such that the cutting plane is at an angle of between about 30 degrees and 90 degrees relative to a flat surface, if the string trimmer were positioned on the flat surface.

13. A string trimmer according to claim 1, wherein, when said trimmer portion is in a trimming position, said rotatable trimmer head is positioned such that the cutting plane is at an angle of between about 10 degrees and 30 degrees relative to a flat surface, if the string trimmer were positioned on the flat surface.

14. A string trimmer according to claim 1, wherein said rotatable trimmer head rotates counterclockwise.
